(19) United States
(12) Patent Application Publication
(10) Pub. No.: US 2026/0273874 A1
(43) Pub. Date: Sep. 17, 2026

(54) ASSEMBLY COMPRISING AT LEAST ONE COMPOSITE PART AND ATTACHMENT MEANS

(71) Applicant: CONSEIL ET TECHNIQUE, Saint-Foy-d'Aigrefeuille (FR)

(72) Inventor: Didier VALEMBOIS, Saint-Foy-d'Aigrefeuille (FR)

(73) Assignee: CONSEIL ET TECHNIQUE, Saint-Foy-d'Aigrefeuille (FR)

(21) Appl. No.: 19/471,496

(22) PCT Filed: Apr. 2, 2024
(86) PCT No.: PCT/EP2024/058882

§ 371 Date: Oct. 1, 2025

(30) Foreign Application Priority Data
Apr. 5, 2023 (FR) FR2303380

(51) Int. Cl. B29C 70/68; B29K 101/12; B29K 105/08

(52) U.S. Cl. CPC B29C 70/682; B29K 2101/12; B29K 2105/0881

(57) ABSTRACT

A fastening with a first composite part, the part is secured, near an attachment zone, to a second part, a bearing edge of the part contacts a bearing edge of the second part. The fastening attaches the first part to the second part. Near the attachment zone, the first part is composed by a drape made of a superposition of unidirectional layers with angles of orientation of fibers that are different between two adjacent layers. Near the attachment zone, at least one cavity is laid out in the first part, parallel to the contact surface and along a direction perpendicular to the direction of the unidirectional layers, and at least one hole perpendicular to the contact surface, where the hole starts from its bearing edge and opens in the cavity, and receives a threaded element.

### FIELD

The present invention relates to the field of composite materials and, more specifically, to a composite part fabricated by means of a specific draping, where this latter is suited for combination with an attachment means for said composite part to any kind of second part.

### BACKGROUND

The attachment of composite parts to another part, whether it is also a composite or a non-composite material, constitutes an important parameter in the design and fabrication of said composite parts.

In fact, particularly, mechanical attachments, like clips or screws, between a composite part and a second part, result in excessive local stresses, such that the attachments represent the weak point of the composite structures and may end in a cracking of the composite and premature failures.

In particular, in conventional attachments, off centering of the attachment relative to the neutral fiber of the part causes flexion. However, this stress is a specific difficulty in the field of composites, because it creates an inconvenient fragile zone in the zone of changing direction, specifically in T-or L-shaped fittings, which is further accentuated by the fact that changes of direction of shells are difficult to implement and therefore costly.

Specifically, in the state-of-the-art, the French patent application FR 2 388 670 is known and describes a fastening intended to reinforce structural joints, comprising a strengthening part with some number of bores for connecting this part to other elements.

Thus, this strengthening part is drilled for a first hole whose axis is parallel to an upper edge of the part. Several transverse holes connecting with the single longitudinal hole opening in the outer edge of the base of the part. This latter may immobilize two elements of a structure, by means of a cylindrical dowel, driven into the single longitudinal hole, and of screws passing through drilled holes, facing transverse holes connecting with the single longitudinal hole. The screws are connected to the dowel to immobilize one to the other of the elements.

Thus, in this composite part, the main hole is made parallel to the direction of the composite layers.

As a consequence of this hole parallel to the direction of the composite layers, the forces due to the attachment elements have a tendency to separate the composite layers which are only held by the resin, under traction.

The connection proposed in this document consequently has a low strength capacity and no proposal was made for giving the fiber strength in the zone of the longitudinal hole.

Further, considering the configuration as described in the aforementioned document, it would be impossible to drill a longitudinal hole along a large dimension wall, or in a wall that was not straight.

### SUMMARY

The goal of the present invention is to remedy, at least in part, the disadvantages of the existing mechanical attachment modes in the domain of composite parts, by proposing implementing an attachment mode allowing the transmission of significant mechanical actions in the main direction of the composite walls, and also allowing a strength of the fiber against separation near the hole.

For this purpose, the invention relates to a fastening comprising, at least, a first composite part made by draping unidirectional fiber layers in a thermoplastic or heat cured matrix, where said first composite part is intended to be secured, near an attachment zone that it comprises, to a second part, composite or not, a bearing edge of said first composite part coming into contact on a bearing edge of said second part, where said fastening further comprises means of attachment of said first composite part to said second part.

Said fastening is specific in that, at least near said attachment zone, said first composite part is composed of a draping constituted of a superposition of unidirectional layers with angles of orientation of the fibers different between two adjacent layers, and in that, in a first implementation example, near said attachment zone, at least one cavity is laid out in said first composite part, parallel to said contact surface and along a direction perpendicular to the direction of the unidirectional layers, and at least one hole along an axis perpendicular to said contact surface, where said hole starts from the bearing edge of said first composite part and opens in said cavity, where said hole is intended to receive a threaded element, whereas said cavity and the second part serve as bearing for tightening elements.

Thus, through the invention, the fact of stressing in the axis of the fiber of the composite part serves to resolve the problems encountered in the existing fastenings in the state-of-the-art.

In a second implementation example of the fastening from the invention, at least one cavity is laid out in said first composite part, parallel to said contact surface created between said first composite part and said second composite part, and along a direction perpendicular to the direction of the unidirectional layers, whereas the hole is drilled along an axis inclined relative to this contact surface.

According to the specific embodiments of the fastening from the invention, whether it involves the first or second implementation example such as described above:
the cavity of said first composite part consists of a slot;
said first composite part comprises an extra thickness of unidirectional fiber layers at least in the attachment zone;
said cavity laid out in said first composite part has a cylindrical shape and the tightening element coming into said cavity consists of a threaded cylinder with dimensions suited to those of said cavity;
the draping of unidirectional fiber layers for said first composite part is constituted of a stacking, repeated n times, composed of a first layer, whose fibers are oriented at 90° with the main axis of said first part, where said first layer is covered over by a sandwich constituted of a central layer whose fibers are oriented at 0° with the main axis of the first part between two intermediate layers whose fibers are oriented at + or −45° with the fibers of said first central layer and with the fibers of the first layer.

The invention also relates to a method for fabrication of a first composite part, constituted by draping unidirectional fiber layers in a thermoplastic or heat cured matrix and securing, by means of the fastening according to the present invention, of said first composite part to a second part, composite or not, near an attachment zone that comprises said first composite part, where a bearing edge of said first composite part comes into contact with a bearing edge of said second part, thus creating a contact surface.

More specifically, said method is characterized in that it comprises, at least, the following steps taken in order:
Draping of said first part by superimposing n layers of unidirectional fibers, where the fibers from two adjacent layers have different angles of orientation, and proceeding with polymerization of the matrix;
Arranging at least one cavity near an attachment zone that comprises said first composite part, where said cavity is parallel to said contact surface and along a direction perpendicular to the direction of the unidirectional layers;
Making at least one hole along an axis perpendicular to said contact surface, starting from the bearing edge of said first composite part and opening into said cavity;
Placing said bearing edge of said first composite part into contact with said bearing edge of said second part, and inserting a threaded element in said hole and tightening elements in said cavity and near said second part for securing said two parts.

When the goal of the method is fabricating the fastening according to the second implementation example of the invention, such as already described above, the steps are similar except for the fact that this hole is drilled along an axis that is inclined relative to said contact surface between the first composite part and the second part who, composite or not.

Other goals and advantages of the present invention will appear through the following description referring to embodiments which are given as indicative and nonlimiting examples.

### BRIEF DESCRIPTION OF THE FIGURES

Understanding of this description will be made easier by referring to the attached drawings and in which:

FIG. 1 shows a schematic and perspective view of a specific embodiment of a fastening conforming to the invention, comprising, on the left of the figure, a first composite part intended to be secured, through an attachment zone and by attachment means, to a second part, composite or not, visible on the right of the figure.

FIG. 2 shows a schematic and section view of the first composite part illustrating the succession of unidirectional fiber layers forming a draping in which the holes, also shown, are arranged.

FIG. 3 shows a schematic view of three nonlimiting implementation examples of composite parts which can be secured to another part, composite or not, through the fastening conforming to the invention, specifically, from left to right, a fitting, a tube, or a turbomachine blade.

FIG. 4 shows a schematic and exploded view of an implementation example of a fastening according to the present invention, in which the first composite part consists of a first fitting type.

FIG. 5 shows a schematic and perspective view of another implementation example of a part of a fastening according to the present invention, in which this latter consists of a second fitting type.

FIG. 6 shows two different views, schematic and perspective, of another implementation example of a part of a fastening according to the present invention, specifically the first composite part, in which this latter consists of the third type of fitting, called multipoint fitting.

FIG. 7 shows two similar schematic and perspective views, one of the two views being an enlargement of a part from the second view, of another implementation example of a part of a fastening according to the present invention, specifically the first composite part, in which this latter consists of an I-beam.

FIG. 8 shows two schematic views, one in section and perspective and the second in section and in its entirety, of another implementation example of a part of the fastening according to the present example, specifically the first composite part, in which this latter consists of a first type of tube having a constant diameter over all of the length thereof.

FIG. 9 shows two schematic views, one in section and perspective and the second in section and in its entirety, of another implementation example of a part of a fastening according to the present example, specifically the first composite part, in which this latter consists of a second type of tube having a larger diameter near the attachment zone of said first composite part to a second part, composite or not, which is not shown in the figure.

FIG. 10 shows a partial schematic view of another implementation example of a part of a fastening according to the present invention, specifically the first composite part which has a flat surface perpendicular to the hole.

FIG. 11 shows a partial schematic view of another implementation example of a part of a fastening according to the present invention, specifically the first composite part, in which the cavity is arranged parallel to a surface of contact between said first part and a second part (not shown), whereas the hole is drilled along an axis inclined relative to this contact surface.

### DETAILED DESCRIPTION

Referring to the figures from the attached drawings, the present invention relates, more specifically, to a fastening 1 comprising, on one side, a first composite part 2 intended to be secured, near an attachment zone 21 that it comprises, to a second part 3.

This second part 3 may also be a composite part. However, it may also involve a non-composite part.

Said second part 3, composite or not, may be considered as being part of the fastening 1 conforming to the invention, or else as not being part of said fastening 1.

Said first composite part 2 is, conventionally, made up of a succession of unidirectional fiber layers 41, 42, 43, 44, 45 in a thermoplastic or heat cured resin.

Said layers 41, 42, 43, 44, 45 are superposed on each other so as to form a draping 4 which is more specifically shown, very schematically, in FIG. 2 of the attached drawings.

According to a specificity of the invention, at least near the attachment zone 21 of said first composite part 2, the draping 4 is made of a superposition of unidirectional fiber layers 41, 42, 43, 44, 45 having angles of orientation of said fibers that are different between two adjacent layers.

Thus, for example, two adjacent layers may advantageously have unidirectional fibers having angles of orientation different by + or −45°, at least near the attachment zone 21 of said first composite part 2 and, preferably over all of said part 2.

Obviously, when the second part 3 to which the first composite part 2 must be secured is also a part in composite material, this latter may be fabricated in the same way as said first composite part 2. It may also be obtained by any other method known to the person skilled in the art for fabricating composite parts.

Returning to the securing of said first composite part 2 and the second part 3, composite or not, this is done, first, by placing a bearing edge 22 which said first composite part 2 comprises in contact near the attachment zone 21, with a bearing edge 32 which the second composite part 3 comprises, which allows the creation of a contact surface between the two parts 2, 3 and then via attachment means 5.

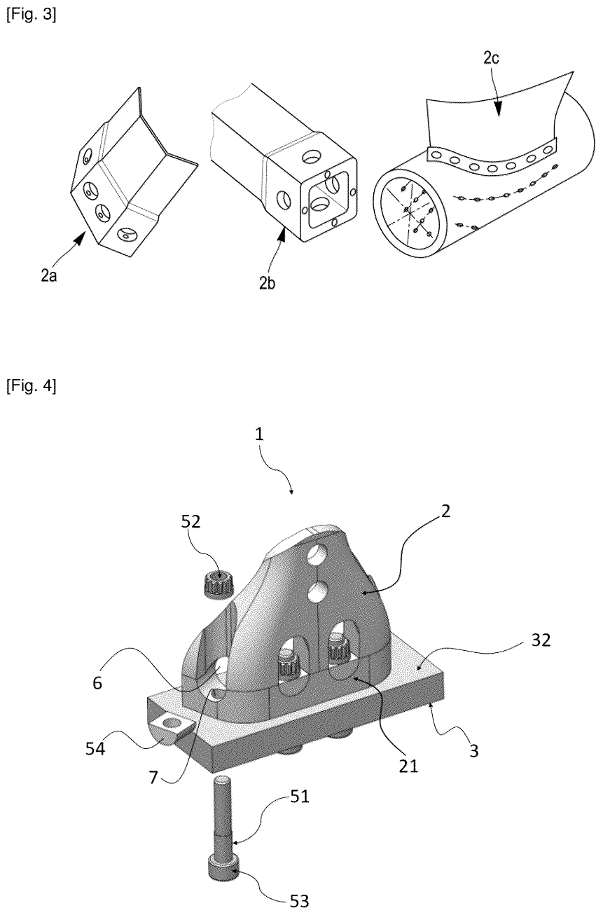

The contact surface between the two parts may be flat or curved (as shown for example in FIG. 3 of the attached drawings, showing a blade fixed onto a tube).

According to another specificity of the fastening 1 from the invention, near the attachment zone 21 of the first composite part 2 at least one cavity 6 is formed in this first composite part 2, along an orientation parallel to said contact surface between said first part 2 and the second part 3. Said cavity 6 is thus perpendicular to the main axis of said part 2. In other words, this means that said cavity 6 is arranged along the direction perpendicular to the main direction of draping 4 of the unidirectional layers 41, 42, 43, 44, 45.

The fact that the axis of drilling of the cavity 6 is in the direction perpendicular to the plane of the draping 4 of the fiber layers 41, 42, 43, 44, 45 serves, together with the arrangement of the unidirectional fiber layers 41, 42, 43, 44, 45, to improve the mechanical strength of the hole during stressing thereof because of the attachments which will be described subsequently.

Consequently, near the hole of the cavity 6, the fiber retains an optimal strength against separation.

Other than said cavity 6, at least one hole 7 is arranged, along an axis perpendicular to said contact surface between the two parts 2, 3, where said hole 7 starts more specifically from the bearing edge 22 of the attachment zone 21 of part 2 and opens in the cavity 6.

Thus, unlike the cavity 6, the hole 7 is done parallel to the direction of the composite layers 41, 42, 43, 44, 45. This being so, since the hole 7 has smaller dimensions than the cavity 6 and does not pass through, it does not negatively influence the strength against separation of the fibers near the attachment zone.

The hole 7 is intended to receive a threaded element 51 that comprises attachment means 5, whereas the cavity 6 and the second part 3 serve for bearing of the tightening elements 52, 53 which also compose attachment means 5.

The cavity 6 is preferably open such that it may consist of a slot, according to the embodiment which is shown in the attached figures.

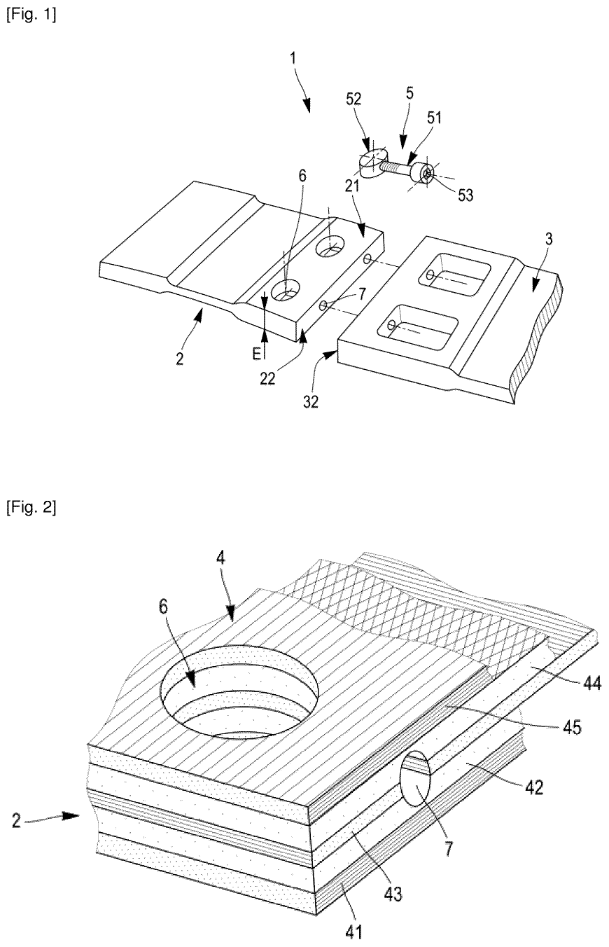

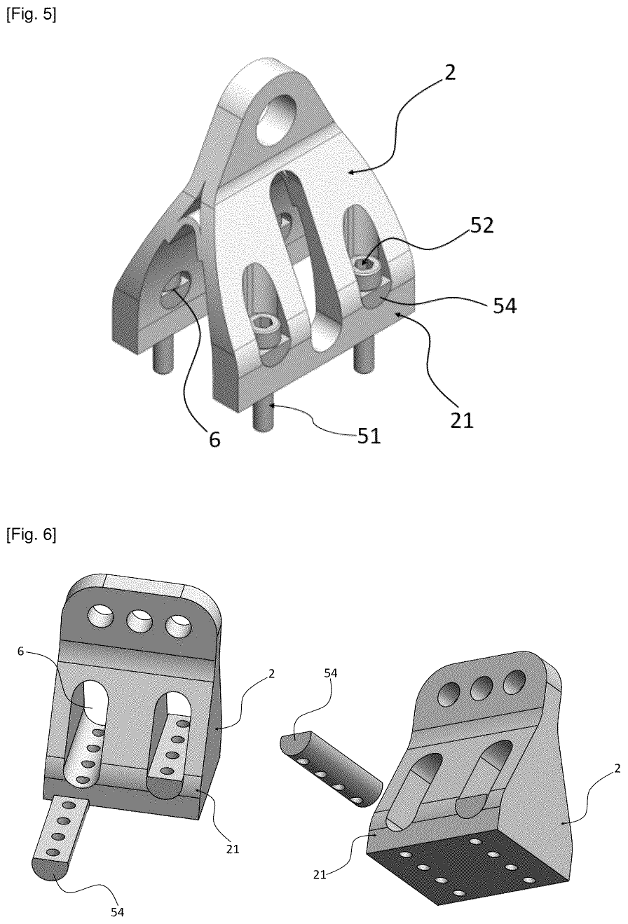

Note that, preferably, and as shown in particular in FIGS. 1 and 3 to 9, the fastening 1 of the present invention more preferably comprises a plurality of cavities 6 and an equivalent number of holes 7, where the quantity and placement of these holes is suited according to the shape and size of said first composite part 2 having to be secured to said second part 3.

Still preferably, and as shown in the attached figures, said cavity 6, or said cavities as may be the case, arranged in said first composite part 2 has (have) a cylindrical shape.

Thus, the tightening element 52 intended to be positioned in said cavity 6 may consist of a threaded cylinder 52 with sizes suited so as to allow insertion thereof within said cavity 6, whereas the attachment means 5 are completed by a screw 51, 53. This particularly preferred embodiment is the one which is shown in FIG. 1 of the attached drawings.

Just the same, it is conceivable that said cavity 6, just like the tightening element 52 intended to be incorporated within said cavity 6, has other shapes and sizes.

Referring to FIG. 10 in the attached drawings, it is thus conceivable that one of the edges of the cavity 6 has, at least partially, or even totally, a flat surface perpendicular to the hole 7. Advantageously this makes it possible to use conventional screws and washers as tightening elements.

Such a design of a fastening 1 conforming to the present invention serves to take up considerable traction force; the strength limit is the mechanical strength of the screws.

Of course, the shapes could be advantageously adapted to allow the attachment by tightening of threaded elements from the side of the first composite part 2 (not shown), or else from the side of the second part 3, composite or not, as is shown on the figures.

Further, intermediate bearing elements 54, visible in FIGS. 4, 5, 6 of half-moon washer type, may possibly supplement the attachment means 5, in particular when the cavity 6 has a concave shape, where the intermediate bearing element 54 then allows tightening on a flat surface.

Note that the draping 4 of the layers 41, 42, 43, 44, 45 of said first composite part 2 may be optimized and, specifically, the piling of the layers 41, 42, 43, 44, which is shown in FIG. 2, turns out to be particularly effective, notably in terms of strength.

More specifically, the draping 4 of layers 41, 42, 43, 44, 45 of unidirectional fibers of said first composite part 3 is made up of a stack of composite layers 41, 42, 43, 44, 45 formed as follows:
placing a first layer 41 whose fibers are oriented at 90° to the main axis of said first part 2;
said first layer 41 is overmolded with a sandwich made up of a central layer 43 whose fibers are oriented at 0° to the main axis of the first composite part 2 between two intermediate layers 42, 44 whose fibers are oriented at + or −45° with the fibers of said first central layer 43 and with the fibers of the first layer 41;
repeating this stacking n times, by restarting with a layer 45 whose fibers are oriented at 90° with the main axis of said first part 2, etc.

Particularly advantageously, said first composite part 2 comprises an extra thickness E of unidirectional fiber layers 41, 42, 43, 44, 45, at least in the attachment zone 21 of this composite part 2 to a second part 3, composite or not.

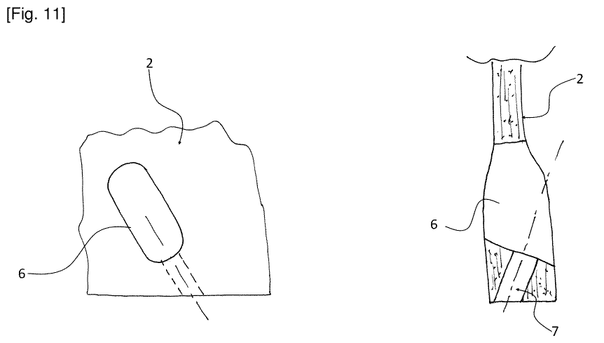

Referring to FIG. 11 in the attached drawings, it shows a part of a fastening according to the invention, specifically the first composite part 2, in a second implementation example of the invention, similar to the first, where the cavity 6 is there again arranged parallel to the contact surface between the two parts 2, 3 to be fastened, and along the direction perpendicular to the draping plane 4 of the unidirectional layers 41, 42, 43, 44, 45, whereas, unlike the first implementation example previously described, the hole 7 is arranged along an axis which is inclined relative to said contact surface created between said two parts 2, 3 to be fastened.

Thus the hole 7 in the representation on the left in FIG. 11, where the tightening element goes, may be inclined in the average plane of the surface of the composite part 2, for example to increase the shearing transmission capacity of the connection, or the torsion torque transmission for a shaft.

As it relates to the part on the right in FIG. 11, the hole 7 may also be inclined in the plane perpendicular to the average plane of the composite surface 2 to improve the placement of the tightening elements.

The set of characteristics which were described above, in connection with the first implementation example of the fastening, in which the first composite part 2 comprises a hole 7 arranged along an axis perpendicular to said contact surface between said first composite part 2 in the second part 3 are also applicable to this second implementation example in which the hole 7 is inclined relative to that contact surface.

The present invention also relates to a fabrication method, on the one hand, for a first composite part 2 made up of a draping 4 of unidirectional fiber layers 41, 42, 43, 44, 45 in a thermoplastic or heat cured matrix, and of securing, on the other hand, by means of the fastening 1 described above, of said first composite part 2 to a second part 3, composite or not.

As already explained, the securing of the two parts 2, 3 is done near an attachment zone 21 which comprises said first composite part 2, a bearing edge 22 of said first composite part 2 coming into contact by a bearing edge 32 of said second part 3, thus creating a contact surface between said first composite part 2 and the second part 3, which may be composite or not.

The method for fabrication and securing conforming to the invention comprises, at least, the following steps taken in order:
Forming the draping 4 of said first part 2 by superimposing n layers of unidirectional fibers 41, 42, 43, 44, 45, where the fibers from two adjacent layers have different angles of orientation of fibers, and proceeding with polymerization of the thermoplastic or heat cured matrix;
note that, preferentially, but optionally, when forming the draping 4, an extra thickness E of unidirectional fiber layers is made at least in the attachment zone 21 of the first composite part 2 which is going to be involved in the following steps of securing it with the second part 3;
Arranging at least one cavity 6 near said attachment zone 21 which comprises said first composite part 2, where it preferably has an extra thickness of fiber layers, where said cavity 6 is formed along an axis parallel to the contact surface between the first composite part 2 and the second part 3, composite or not, where said cavity 6 is arranged along a direction perpendicular to the main direction of the draping 4 of unidirectional layers 41, 42, 43, 44, 45;
Making at least one hole 7 along an axis perpendicular to the contact surface or, depending on the case, inclined relative to that contact surface, starting from the bearing edge 22 of said first composite part 2 and opening in the cavity 6 which was drilled in the attachment zone 21 in the preceding step;
Placing said bearing edge 22 of said first composite part 2 into contact with said bearing edge 32 of said second part 3, and inserting a threaded element 51 in said hole 7 and tightening elements 52, 53 in said cavity 6 and near said second part 3 for securing said first composite part 2 with said second part 3.

The preferred elements and characteristics which were described in connection with the fastening 1 from the invention may obviously be applied to the method from the invention, in particular, as it relates to the sequencing of the fiber layers for forming the draping 4 and as it relates to the plurality of cavities 6 and holes 7 which may be provided near the fastening zone 21 of the first composite part 2.

Now referring to FIG. 3 from the attached drawings, note that the attachment system conforming to the invention could follow the geometric progression of the wall of the composite part 2 to be attached, so as to optimize the cohesion of the fastening between said composite part 2 and a second part 3, in particular during stresses which could be complex or in complex geometries, such as the fittings 2a, tubes 2b or turbomachine blades 2c.

FIG. 4 and following show various applications of the present invention for a connection of the first composite part 2 to a second part 3, composite or not.

Thus, on FIGS. 4, 5, 6, the first composite part 2 consists of a fitting, in particular a multipoint fitting on FIG. 6.

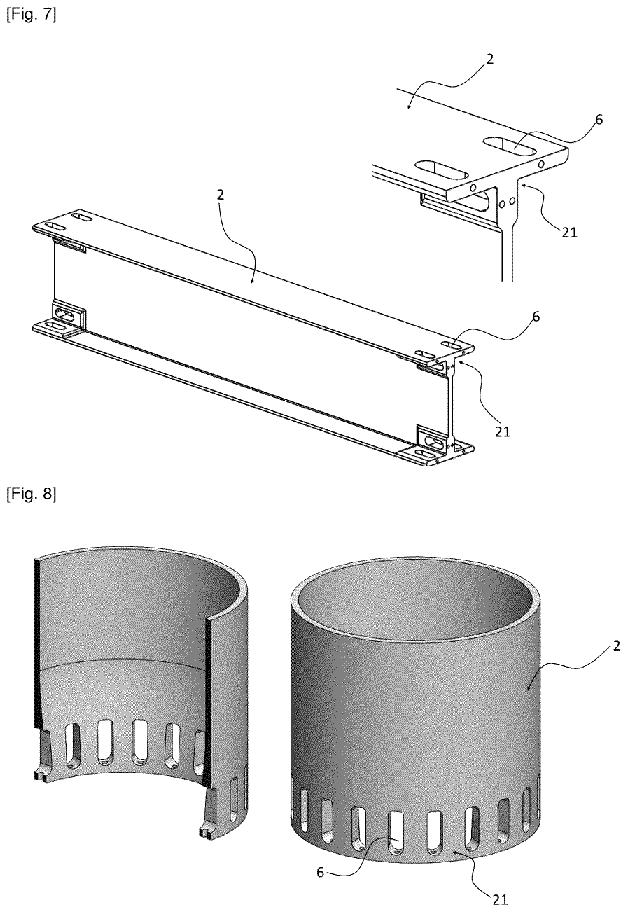

In FIG. 7, the first composite part 2 consists of an I-beam.

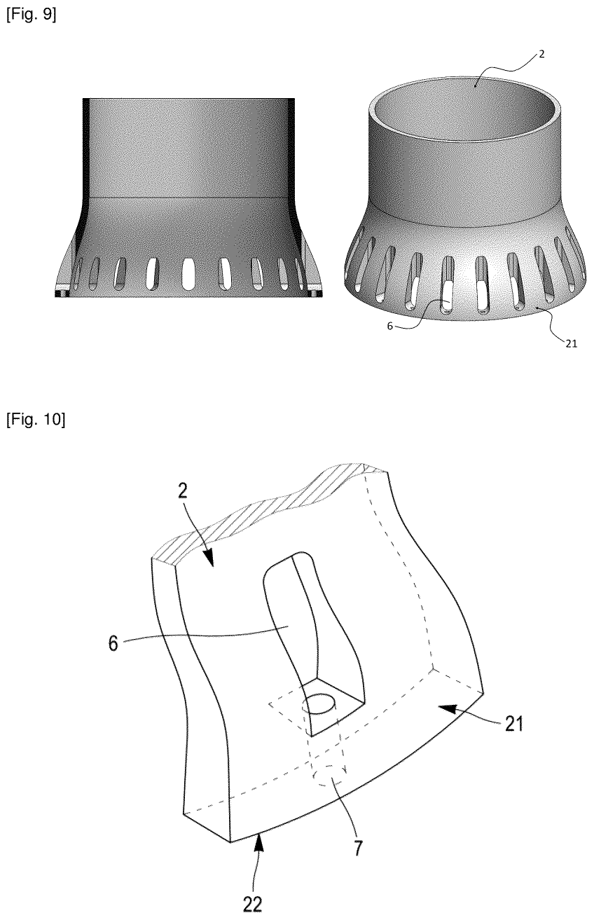

In FIGS. 8 and 9, the first composite part 2 consists of a tube.

The tube from FIG. 8 has a constant diameter over its full length, and, near the attachment zone 21, the thickness is increased in order to compensate for the reduction of material and in order to have the necessary thickness for the attachment means.

FIG. 9 shows a tube with larger diameter near the zone of attachment 21 of said first composite part 2 to a second composite part 3, so as to allow a clearance to make placement of attachment means easier and for axial access to these attachment means (not shown in the figure).

In this specific application, shown in FIG. 9, note that the axis of attachment is offset relative to the main axis of the composite part 2 which allows adapting the shape of the composite part to the mode of attachment for strengthening near the attachment zone.

More generally, the invention has applications in the implementation of aeronautic fittings, transmission shafts, masts, beams, etc.

1-7. (canceled)

8. A fastening comprising at least, a first composite part made by draping unidirectional fiber layers in a thermoplastic or heat cured matrix, where said first composite part is intended to be secured, near an attachment zone that it comprises, to a second part, composite or not, a bearing edge of said first composite part coming into contact on a bearing edge of said second part, where said fastening further comprises means of attachment of said first composite part to said second part and wherein, at least near said attachment zone, said first composite part is composed of a draping constituted of a superposition of unidirectional layers with angles of orientation of the fibers different between two adjacent layers, and in that, near said attachment zone, at least one cavity is laid out in said first composite part, parallel to said contact surface and along a direction perpendicular to the direction of the unidirectional layers, and at least one hole along an axis perpendicular to said contact surface, where said hole starts from the bearing edge of said first composite part and opens in said cavity, where said hole is intended to receive a threaded element, whereas said cavity and the second part serve as bearing for tightening elements.

9. The fastening according to claim 8, wherein the cavity of said first composite part consists of a slot.

10. The fastening according to claim 8, wherein said first composite part comprises an extra thickness of unidirectional fiber layers, at least in the attachment zone.

11. The fastening according to claim 8, wherein said cavity laid out in said first composite part has a cylindrical shape and the tightening element coming into said cavity consists of a threaded cylinder with dimensions suited to those of said cavity.

12. The fastening according to claim 8, wherein the draping of unidirectional fiber layers for said first composite part is constituted of a stacking, repeated n times, composed of a first layer, whose fibers are oriented at 90° with the main axis of said first part, where said first layer is covered over by a sandwich constituted of a central layer whose fibers are oriented at 0° with the main axis of the first part between two intermediate layers whose fibers are oriented at + or −45° with the fibers of said first central layer and with the fibers of the first layer.

13. A method for fabrication of a first composite part, constituted by draping unidirectional fiber layers in a thermoplastic or heat cured matrix and securing, by means of the fastening according to claim 8, of said first composite part to a second part, composite or not, near an attachment zone that comprises said first composite part, where a bearing edge of said first composite part comes into contact with a bearing edge of said second part creating a contact surface, where said method comprises, at least, the following steps, taken in order:
forming the draping of said first part by superimposing n layers of unidirectional fibers, where the fibers from two adjacent layers have different angles of orientation, and proceeding with polymerization of the matrix;
arranging at least one cavity near an attachment zone that comprises said first composite part, where said cavity is parallel to said contact surface and along a direction perpendicular to the direction of the unidirectional layers;
making at least one hole along an axis perpendicular to said contact surface, starting from the bearing edge of said first composite part and opening into said cavity; and
placing said bearing edge of said first composite part into contact with said bearing edge of said second part, and inserting a threaded element in said hole and tightening elements in said cavity and near said second part for securing said two parts.

14. A fastening comprising, at least, a first composite part made by draping unidirectional fiber layers in a thermoplastic or heat cured matrix, where said first composite part is intended to be secured, near an attachment zone that it comprises, to a second part, composite or not, a bearing edge of said first composite part coming into contact on a bearing edge of said second part, where said fastening further comprises means of attachment of said first composite part to said second part and wherein, at least near said attachment zone, said first composite part is composed of a draping constituted of a superposition of unidirectional layers with angles of orientation of the fibers different between two adjacent layers, and wherein, near said attachment zone, at least one cavity is laid out in said first composite part, parallel to said contact surface and along a direction perpendicular to the direction of the unidirectional layers, and at least one hole along an axis inclined relative to said contact surface, where said hole starts from the bearing edge of said first composite part and opens in said cavity, where said hole is intended to receive a threaded element, whereas said cavity and the second part serve as bearing for tightening elements.
